(19) United States
(12) Patent Application Publication
(10) Pub. No.: US 2018/0211284 A1
(43) Pub. Date: Jul. 26, 2018

(54) CUSTOMIZED ADVERTISEMENT AND MESSAGE CONTENT FOR PRESENTATION AT PICKUP LOCATIONS

(71) Applicant: Amazon Technologies, Inc., Reno, NV (US)

(72) Inventors: Raghavan Srinivasan, Bellevue, WA (US); Neha Goswami, Seattle, WA (US); Denis Trong Nguyen, Seattle, WA (US); Nicholas John Morren, Seattle, WA (US)

(21) Appl. No.: 13/953,696

(22) Filed: Jul. 29, 2013

(51) Int. Cl. G06Q 30/02

(52) U.S. Cl. CPC G06Q 30/0269

(57) ABSTRACT

Content such as a customized advertisement or message may be presented to a user at a pickup location. The content may be presented utilizing an audiovisual or other device of the pickup location, or on a user's mobile device when the user arrives at the pickup location. An advertisement that is presented to the user may be selected based on factors such as past purchases made by the user, a current item in an order or an item available for purchase in a store that is near the pickup location. A message that is presented to the user may be from a gift purchaser who ordered an item for the user, a manufacturer or vendor of an item, or the user with a reminder for a task that is to be performed when the user is at the pickup location.

### BACKGROUND

Many companies package items and/or groups of items together for a variety of purposes, such as e-commerce and mail-order companies that package items (e.g., books, CDs, apparel, food, etc.) to be shipped to fulfill orders from customers. Retailers, wholesalers, and other product distributors (which may collectively be referred to as distributors) typically maintain an inventory of various items that may be ordered by customers. This inventory may be maintained and processed at a materials handling facility which may include, but is not limited to, one or more of: warehouses, distribution centers, cross-docking facilities, order fulfillment facilities, packaging facilities, shipping facilities, or other facilities or combinations of facilities for performing one or more functions of material (inventory) handling.

Advertisements or messages such as gift messages are sometimes included in a package with an order for a customer. Such advertisements or messages that are included in a package are typically limited to print media. Musical or otherwise recordable greeting cards are available, but tend to be expensive and limited in terms of the content that can be presented. Other electronic and audiovisual means for sending messages or advertisements are not typically able to be timed to arrive at the same time as a package with an order. For messages such as gift messages, timing may be particularly important where it is desirable for the message to arrive at the same time as the gift.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a broad view of the operation of a materials handling facility, in one implementation.

FIG. 2 depicts a block diagram of a pickup location, in one implementation.

FIG. 3 depicts a block diagram of an illustrative distributed pickup location environment, in one implementation.

FIG. 4 is a flow diagram illustrating an example process for processing an order for an item.

FIG. 5 is a flow diagram illustrating an example process for selecting an advertisement to be presented to a user.

FIG. 6 is a flow diagram illustrating an example process for selecting a message to be presented to a user.

FIG. 7 is a flow diagram illustrating an example process for a pickup location activity.

FIG. 8 is a block diagram illustrating an example computer system configured to implement one or more of the systems or processes described herein.

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

This disclosure describes systems and methods for presenting customized advertisements and messages to users at pickup locations. A pickup location may include a control station and storage compartments where items that are ordered from a fulfillment center can be delivered for pickup by users. For example, a user may order an item and designate a pickup location as the delivery location. Rather than shipping the item to a residence or place of business, the item may be shipped to the pickup location and stored in a storage compartment for retrieval by a user. A pickup location may also be utilized by a user for other activities, such as dropping off an item for shipment. Content such as a customized advertisement or message may be presented to a user at the pickup location. For example, Adam may send a gift to Eve and include a personal message. When Eve goes to a pickup location to retrieve the gift, the personal message is presented on a display of the control station of the pickup location. Other audiovisual devices of the pickup location may also be utilized, such as a projection device which may project the content on a door or other surface of a storage compartment where the item is located. A user may also be provided with an option to have the content presented on their mobile device or otherwise sent to them electronically. The user may also be provided with an option to have the content presented while they are at the pickup location or at a later time.

An advertisement that is to be presented to the user may be selected based on content related factors that are associated with the user. For example, a user's past purchases, wishlists or browsing history may be utilized as a basis for selecting advertisements for associated items. Similarly, the current item in the order for the user may be utilized as a basis for selecting advertisements for complimentary items or other items that are often purchased with the current item in the order. An advertisement may also be selected for an item in a store that is near the pickup location where the user will be when they retrieve the current item in the order, and may include a coupon for purchasing the advertised item. An advertisement may also be selected for an item that is currently in a storage compartment of the pickup location which the user can retrieve immediately after purchase.

In one implementation, the selection of the advertisement may be performed at a control station of the pickup location. In another implementation, a remote computing resource that receives and synchronizes order information with the pickup location may be utilized to perform the selection of the advertisement. The selection of the advertisement may be performed when the user is at the pickup location, or may be performed in advance. For a remote computing resource, by selecting and synchronizing the advertisement in advance, the advertisement may still be presented at the pickup location even if network communications are not available when the user is at the pickup location.

Content such as a message for the user may be provided from various sources. For example, a gift message may be sent from someone who purchased the item as a gift for the user. The gift purchaser may be provided with various options for customizing the gift message, such as audiovisual components that can be included in the message. A message may also be provided from a manufacturer or vendor of the current item in the order, and may include information about the item. A message may also be provided from the user themselves. In one implementation, when a user places an order, the user may wish to have a message presented when they are at the pickup location to remind them of a task that is to be performed. For example, the pickup location may be near a grocery store and the message may include a grocery list for the user.

The user may also be provided with an option to interact with the content that is presented. For example, when the content is a message the user may be provided with an option for sending a response to the message through a user interface of the pickup location. For a gift message, the user may be able to send a thank you or other message back to the gift purchaser. As another example, if the content is an advertisement, the user may be provided with an option to purchase the advertised item or otherwise seek additional information about the item through a user interface of the pickup location. In another example, the advertisement or related item such as a coupon, may also be transferred to an electronic device/account for usage or printed using a printer. The printer may be associated with the materials handling facility and/or pickup location.

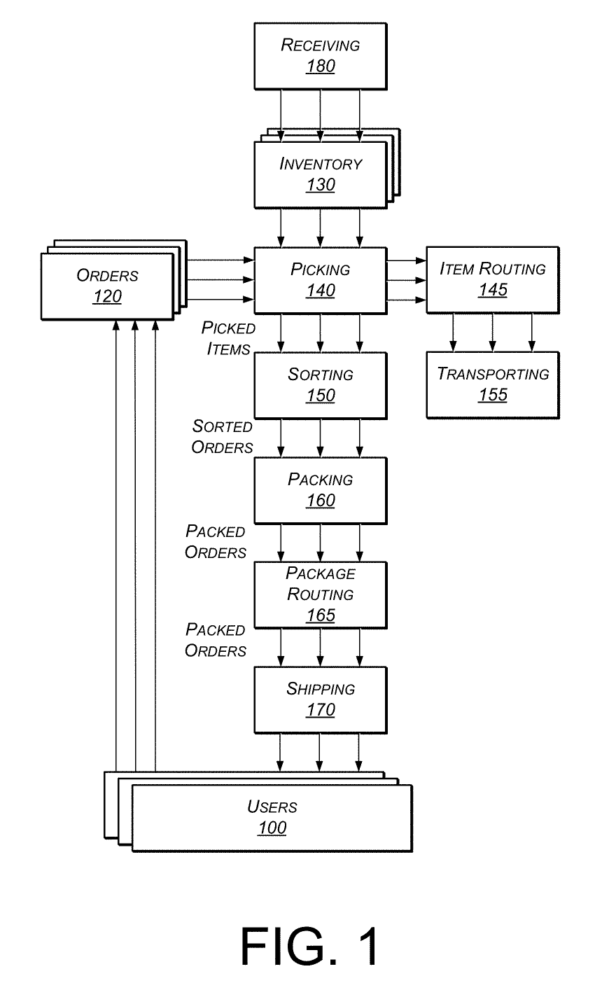

A block diagram of a materials handling facility, which, in one implementation, may be an order fulfillment facility configured to utilize various systems and methods described herein, is illustrated in FIG. 1. In this example, multiple users 100 may submit orders 120, where each order 120 specifies one or more items from inventory 130 to be shipped to the user or to another entity specified in the order. An order fulfillment facility typically includes a receiving operation 180 for receiving shipments of stock from various vendors and storing the received stock in inventory 130. To fulfill the orders 120, the item(s) specified in each order may be retrieved or “picked” from inventory 130 (which may also be referred to as stock storage) in the order fulfillment facility, as indicated by picking operation 140. In some implementations, the items of a user order may be divided into multiple shipment sets for fulfillment by a planning service before fulfillment instructions are generated (not shown). As used herein, the term “shipment set” may refer to a single item of a user's order, multiple items of a user's order, or all items of a user's order.

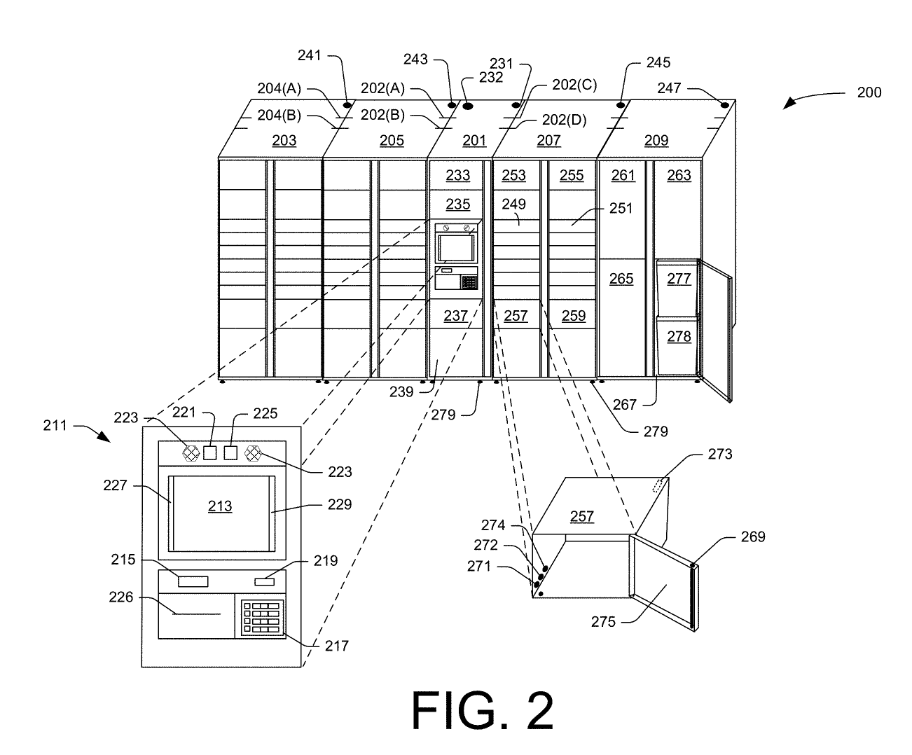

In some instances, when a user has selected a pickup location, such as the pickup location described below with respect to FIG. 2, as the delivery destination, the item(s) of one or more shipment sets may be picked at the picking operation 140 directly into delivery containers. A “delivery container,” as used herein, may be any form of container used in transporting or handling items. For example, a delivery container may be a tote, pallet, bin, trailer, etc. Additionally, the delivery container may be segmented or otherwise include division points, permanent or movable, that enable separation of items within the delivery container. In some instances, items themselves, such as larger items (e.g., big screen televisions, desks, cabinets) may be considered and treated as delivery containers. The delivery container may also include a unique identifier, such as a bar code, QR code, unique number, etc. to enable tracking and identification of the delivery container and association of items placed in the delivery container. For example, during a picking operation, an agent within the materials handling facility may scan the bar code of the delivery container and scan a barcode or identifier of the picked item as the item is placed into the delivery container. Scanning of the delivery container and the picked item results in the item becoming associated with and tracked with the delivery container. In some implementations, for delivery containers that are segmented or otherwise include division points, those segments may each include a unique identifier (e.g., bar code) and as items are placed in the delivery container they may be associated with a specific location, or segment within the delivery container by scanning the identifier of that segment. Likewise, because items may not be packed in shipping packages, the packing slip typically included in a shipping package may be applied to the item (e.g., stickered to the item), printed out at the pickup location upon retrieval of the item, or otherwise made available to a user.

Regardless of the type of delivery container utilized, in some implementations, items for which a pickup location has been selected as the final delivery destination do not need to be packed in a shipping package and can be transported to the pickup location in the delivery container. In other instances, items that are pre-packaged or fragile items that need additional protection prior to transport may be picked and transported to a pickup location in a delivery container. In another implementation, items may be put in bags prior to placement in the delivery container and/or storage compartment to provide confidentiality of the ordered items. In addition, items from multiple shipment sets destined for the same pickup location may be picked into the same delivery container for transport. As delivery containers are filled, an item routing operation 145 may route the filled delivery containers to the appropriate transporting operation 155 for transport to the designated pickup location. The item routing operation 145 may be manual or automated. The item routing operation 145 may receive an indication of the pickup location in which each item should be routed from a shipment planning system and route delivery containers to one of two or more transporting operations 170, from which they may be transported to the pickup location.

In other examples, for items not scheduled for delivery to a pickup location, picked items may be delivered to one or more stations in the order fulfillment facility for sorting 150 into their respective shipment sets and for packing 160 in shipping packages. A package routing operation 165 may sort orders for packing in shipping packages to one of two or more shipping operations 170, from which they may be shipped to the users 100. The package routing operation 165 may in various implementations be automated or manual. The package routing operation 165 may receive an indication of the destination to which each packed shipment set should be routed from a central control system. In some instances, the destination may be the final destination identified by the user or a pickup location at which transfer of a shipment set may occur for final delivery to the user. The package routing operation 165 may also determine a routing destination for each packed shipment set dependent on the size of a shipping package in which the shipment set is contained and/or based on whether the shipment set will be delivered directly to the user or be delivered to a pickup location at which transfer of the shipment set will occur for final delivery to the user.

The arrangement and order of operations illustrated by FIG. 1 is merely one example of many possible implementations of the operation of a materials handling facility, such as an order fulfillment facility, that enables transport of items directly to pickup locations without packing the items. Other types of materials handling, manufacturing, or order fulfillment facilities may include different, fewer, or additional operations and resources, according to different implementations.

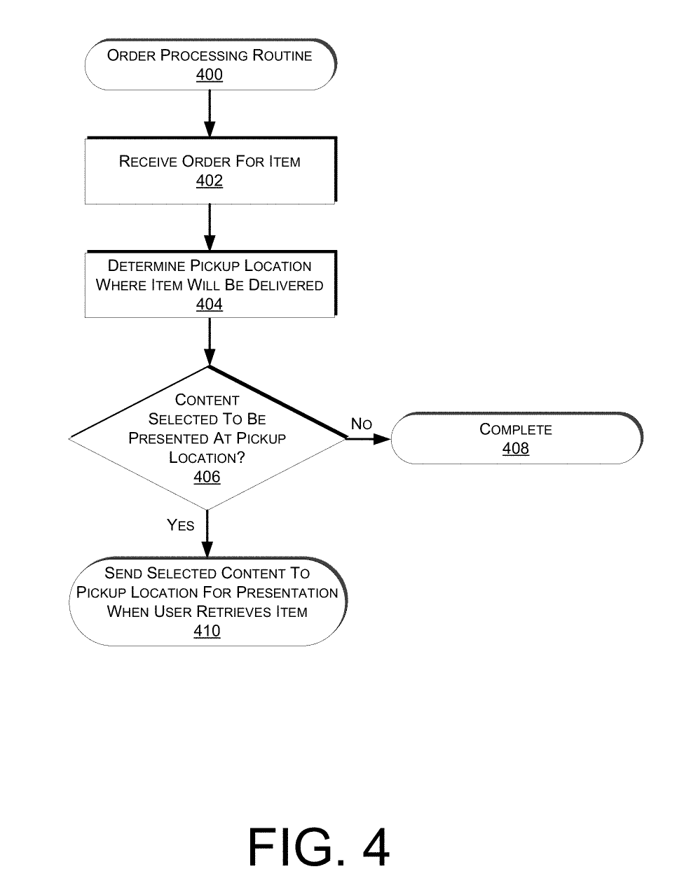

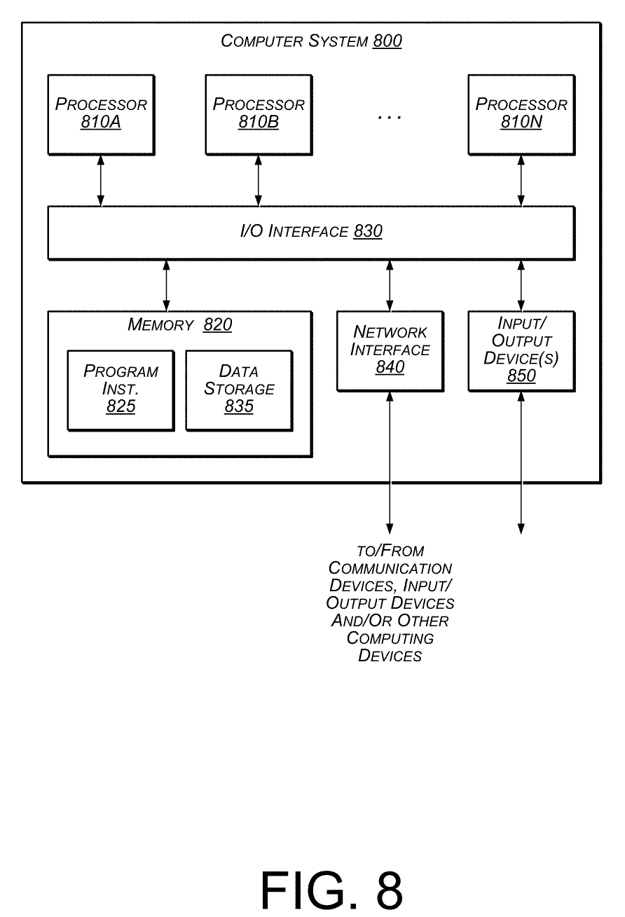

FIG. 2 depicts a block diagram of a pickup location 200, in one implementation. The pickup location 200 may include one or more control stations 201 and one or more storage compartment modules 203, 205, 207, 209. The control station 201 acts as the central control point for the pickup location 200, providing power, computing resources, user input and network access to the pickup location 200. For example, control station 201 may include an internal computing system (not shown), such as a computing system described below with respect to FIG. 8, or other computing system, that is capable of maintaining state information for each storage compartment at the pickup location 200 and providing other computing functions. For example, the internal computing system may include a command component that maintains information as to which storage compartments of the pickup location 200 are empty, which storage compartments include items, the access code(s) or other identifier(s) necessary to open each of the storage compartments and any other information necessary to maintain the pickup location. The command component may also issue commands or instructions to the storage compartment modules to lock/unlock storage compartments, active sensors, and the like. The pickup location 200 may be configured to obtain information from a remote computing resource, shipment planning system, capacity planning system or material handling facility or may be configured to operate primarily as a stand-alone unit, with limited external communication to provide capacity information and/or to receive/provide order/delivery/transfer information. FIG. 3, described below, illustrates an example of an environment in which a centralized control system is provided for remotely communicating with a group of geographically distributed pickup locations 200.

The control station 201 may also include a user interface 211. The user interface 211 is configured to receive and provide information to one or more users of the pickup location 200 and may include, but is not limited to, a display 213, such as a touch-screen display, a scanner 215, a keypad 217, a biometric scanner 219, an audio transducer 221, one or more speakers 223, one or more image capture devices 225, such as a video camera, and any other types of input or output devices that may support interaction between the pickup location 200 and one or more users. For example, the user interface 211 may also include a credit card reader, the ability to accept money (such as cash or coins) and/or the ability to vend items (e.g., stamps, labels, envelopes, shipping packages) using a vending slot 226. Providing the ability for the pickup location 200 to accept credit cards and/or money enables the delivery of orders to a storage compartment at the pickup location 200 for which the items are paid for at the time of pickup (e.g. cash on delivery). Likewise enabling vending of items, such as stamps or envelopes, supports the ability for users to utilize a pickup location to ship or deliver goods, as described in more detail below.

In addition to including user input and output devices, the user interface 211 may also include the ability to collect particulates, such as for use in detection of hazardous (e.g., explosives) or banned substances (e.g. drugs). In one implementation, the user interface 211 may include a particulate sensor that includes a forced air ejection component 227 and an air intake component 229. The air ejection component expels air from a left side of the display 213 while a user is interacting with or otherwise within a predetermined range of the display 213. Opposite the air ejection component 227, the air intake component 229 collects the ejected air and any particulates that are collected as the air passes over the display 213 and past the user's hand or fingers as they interact with the display 213. Collected particulates may be scanned or otherwise processed to determine if potentially hazardous or banned substances may be placed in a storage compartment using any known particulate testing technique. If particulates indicating the potential presence of hazardous or banned substances are detected, the control station 201 may determine to not open a storage compartment door, may alert the authorities, or take other protective actions (such as shutting down the pickup location or performing additional tests).

The control station 201 may also include a connector component configured to provide wired and/or wireless network connectivity with the other storage compartment modules 203, 205, 207, 209, as well as to remote computing devices (FIG. 3) or materials handling facilities. Wireless connectivity may be implemented using a wireless antenna 231, which may provide both receive and transmit functionality. Power and/or network communication with remote computing devices may be obtained from a main access point 232. In addition, in some implementations, the control station 201 may include one or more storage compartments 233, 235, 237, 239. As described in more detail below with respect to the storage compartment modules 203, 205, 207, 209, the storage compartments 233, 235, 237, 239 of the control station 201 may be of any size or configuration. As with each of the other storage compartments, the storage compartments 233, 235, 237, 239 of the control station 201 may include an automated locking mechanism, image capture device, a motion or presence detection mechanism, temperature sensor, etc. Alternatively, in some implementations one or more of the storage compartments may be utilized as an additional user interface. For example, storage compartment 239 may be removed and the space remaining may be utilized to provide a scale or other type of weight determination component to allow users to weigh items for shipment, determine the cost necessary to ship the item, and pay for shipping using the user interface 211.

The control station 201 may include one or more connector components 202(A), 202(B), 202(C), 202(D) to which a storage compartment module, such as storage compartment module 205 or storage compartment module 207 may connect with the control station 201. For example, connector component 202(A) may provide power to storage compartment module 205, connector component 202(B) may provide communication with storage compartment module 205, connector component 202(C) may provide power to storage compartment module 207 and connector component 202(D) may provide communication with storage compartment module 207. Likewise, the storage compartment modules may also include one or more connector component, such as connector component 204(A), 204(B) to provide power and connectivity to additional storage compartment modules, such as storage compartment module 203.

Each storage compartment module, such as storage compartment modules 203, 205, 207, 209, may be configured so the pickup location 200 is modular, such that one or more storage compartment modules can be easily removed or added to the control station 201 of the pickup location 200. The ability to add or remove storage compartment modules at a pickup location 200 supports the ability to easily and quickly expand or remove capacity so that the demand for that pickup location can be satisfied. For example, during the Christmas holiday season, additional storage compartment modules may need to be added to the pickup location 200 to support the increased demand of items ordered by users. As storage compartment modules 203, 205, 207, 209 are added or removed from a pickup location 200, the control station 201 informs the warehouse management system and/or a capacity planning system of the added or removed capacity.

Each storage compartment module 203, 205, 207, 209 includes one or more storage compartments, one or more receptor components for connecting with connector components of a control station 201 (or another storage compartment module) and one or more connector components for allowing other storage compartment modules to connect thereto, thereby providing power and/or connectivity with the control station 201. The storage compartments of each storage compartment module may be of varying sizes and number. As such, storage compartment modules with different storage compartment sizes can be added to a pickup location 200 to optimize the storage compartment configuration to match that of the sizes of orders typically scheduled for delivery to the pickup location.

In addition to including storage compartments, power and connectivity points, the storage compartment modules 203, 205, 207, 209 may also include one or more wireless antennas 241, 243, 245, 247 and one or more computing systems, such as the computing system described with respect to FIG. 8, or a simpler computing system such as a printed circuit board, RFID tag, or anything else that may be detectable by the control station 201 and used to identify the storage compartment module. The computing component(s) of each storage compartment module may include a unique identifier of the storage compartment module and configuration information of the storage compartment module, which includes dimension information and location information of each storage compartment of the storage compartment module. The computing component may also include a storage compartment management component configured to control the actuators that enable locking and unlocking of the storage compartment doors of the storage compartment module 203, 205, 207, 209 in response to receiving commands or instructions from a command component of the control station 201.

A storage compartment module, such as storage compartment module 207, when added to a control station 201 and power is applied, provides information to the control station 201 identifying the storage compartment module 207, the number, location, and dimensions of each storage compartment of the storage compartment module and any other configuration or information necessary to enable the control station 201 to control the storage compartment module 207. As illustrated by the comparison between storage compartment module 207 and storage compartment module 209, each storage compartment module may have a variety of different configurations, sizes and numbers of storage compartments. For example, storage compartment module 207 includes a group of small storage compartments, such as small storage compartments 249, 251, a group of medium-sized storage compartments, such as medium-sized storage compartments 253, 255 and a group of larger storage compartments, such as larger storage compartments 257, 259. In contrast, storage compartment module 209 includes four very large storage compartments 261, 263, 265, 267. It will be appreciated that any number, size and configuration of storage compartments of a storage compartment module may be utilized with the various implementations described herein.

In an alternative implementation, rather than providing all of the information from the storage compartment module to the control station 201, the storage compartment module 207 may only provide limited information, such an identifier, to the control station 201. The control station 201, upon receiving the limited information from an added storage compartment module 207, may make a request to a remote computing system, such as a capacity planning system, and obtain information about the configuration, number and sizes of the storage compartments of the added storage compartment module 207.

The control station 201, upon receiving identifying information of an added storage compartment module 207, may allocate the added capacity to the pickup location 200, and may inform a remote computing resource such as will be described in more detail below with respect to FIG. 3. In various implementations, the added storage compartment module may act as a slave component for the control station, receiving instructions (e.g., open storage compartment, close storage compartment, activate image capture device, monitor motion sensor) from the command component of the control station 201 and providing responses (e.g., closed-door, closed, open-door, object/movement detected) to the control station 201 via the storage compartment management component.

Each storage compartment of a storage compartment module 203, 205, 207, 209 or control station 201 includes an upper, bottom, side and rear surfaces and at least one door configured to form a cavity in which items may be stored. In addition, each storage compartment may include various security or other components. For example, looking at the expanded view of storage compartment 257, disposed within the cavity the storage compartment may include a locking mechanism 269, which may be controlled remotely by the command component of the control station 201 via the storage compartment management component, a presence detection sensor 271, motion sensor 272, an image capture device 273, a temperature sensor 274, and a mirror (or other reflective surface) on the top inside of the storage compartment unit (not shown). The locking mechanism 269 may be controlled by the control station 201, either through wired or wireless communication with the storage compartment management component, to effect locking and unlocking of the door 275 of the storage compartment 257. For example, when a user interacts with the control station 201 via the display 213 and provides an access code or other identifier, the control station 201 may identify a specific storage compartment associated with the access code or other identifier and the command component may wirelessly send instructions to the storage compartment management component of the storage compartment module 207 to unlock a storage compartment 257. The instructions may include a command (e.g., unlock), an address or identifier of the specific storage compartment and any other information necessary for communication between the control station 201 and the storage compartment module 207. In response to receiving the instructions from the command component, the storage compartment management component of the storage compartment module 207 may activate a locking mechanism that moves the pins of the locking mechanism 269 on the door 275 of the identified storage compartment 257 such that the pins retract, thereby disengaging the lock of the storage compartment 257 allowing the door 275 to open. In some implementations, the storage compartment 257 may also include a spring mechanism (not shown) such that when the locking mechanism 269 of the storage compartment 257 is disengaged, the spring mechanism propels the door 275 outward, thereby identifying to a user that the door 275 is unlocked and the storage compartment 257 is accessible.

While the locking mechanism described above utilizes retractable pins, any mechanical, magnetic, electrical or other form of locking mechanism may be utilized with the various implements described herein. In addition, the storage compartment 257 may also include magnets to help retrieve and close a door when it is not all the way closed. Also, the locking mechanism of different storage compartments and different storage compartment modules may be the same or different. Moreover, while the above example describes sending instructions from the command component of the control station 201 to the storage compartment management component of the storage compartment module, in other implementations, each storage compartment may be controlled and/or communicated with directly by the control station 201 and/or the command component and/or remote computing resources as will be described in more detail below with respect to FIG. 3.

The presence detection sensor 271 may be used to detect the presence or absence of objects in the storage compartment 257. For example, the presence detection sensor 271 may be utilized when a carrier is placing items, delivery containers and/or transfer containers in the storage compartment 257 to confirm that the item is indeed in the storage compartment 257 before the door 275 is closed and locked by the locking mechanism 269. Additionally, the presence detection sensor 271 and/or motion sensor 272 may also be used when a user is picking up an order stored in the storage compartment 257 or when a carrier is removing items, delivery containers and/or transfer containers from the storage compartment 257. For example, when a user interacts with the control station 201 via the touch control display 213 and provides an access code such that a storage compartment 257 is opened, the presence detection sensor 271 and/or motion sensor 272 may be used to confirm that a user has reached into the storage compartment 257 and removed its contents (or added items in the case of returns or shipping), prior to allowing the storage compartment door 275 to be closed and locked with the locking mechanism 269. In some implementations, there may be multiple presence detection sensors 271 and/or motion sensors 272 distributed throughout the inside of a storage compartment to ensure objects/motion is detected. In still another implementation, the bottom of the storage compartment may include protrusions or rises to position thin items so they are detected by the presence detection sensor 271.

The storage compartments, such as storage compartment 257, may also include an image capture device 273, such as a camera, and optionally an illumination component (not shown), such as a light emitting diode (LED), that may be used to illuminate the inside of the storage compartment 257. The image capture device 273 may also be used to the detect presence or absence of items within the storage compartment 257, detect the item itself, for example to simplify returns, as well as for security. For example, the image capture device 273 may be used to identify the type of object located within the storage compartment 257 and/or to identify or record video/images of access with the storage compartment 257. In addition, the image capture device 273 may be used to determine the amount of space available in the storage compartment 257. For example, an image taken by the image capture device 273 may be transmitted via wired or wireless communication to the control station 201 and the control station 201 may determine the amount of space available in the storage compartment 257. Such information may be used to determine if all items of a shipment set will fit in a single storage compartment 257, if all items associated with a storage compartment are present in the storage compartment, or if the shipment set needs to be divided across multiple storage compartments. In addition, the image capture device 273 may also be used to determine if there is sufficient space in a storage compartment 267 to contain a delivery container 277 and/or transfer container 278.

Some storage compartments, such as storage compartments located vertically higher within a storage compartment module 203, 205, 207, 209 or the control station 201, such as storage compartments 233, 235, 253, 255 may also include a reflective surface, such as a mirror, on the inside top, sides and/or back of the storage compartment to enable a user who cannot see directly into the storage compartment to determine via a reflection off the reflective surface whether they have removed all of the items from the storage compartment. In a similar manner, a reflective surface may be included on the bottom, sides or back of a storage compartment, such as storage compartment 239, located lower within a storage compartment module 203, 205, 207, 209 or the control station 201, so users can determine via a reflection, and without having to bend all the way down to see into the storage compartment, whether all items have been removed.

The image capture device 273 may also be used to determine if all of the items have been removed from the storage compartment 257. For example, a current image taken by the image capture device 273 may be compared to a prior image taken when the storage compartment 257 was empty in order to verify that all of the items have been removed from the storage compartment. In one implementation, the current image taken by the image capture device 273 may be transmitted via wired or wireless communication to the control station 201 and the control station 201 may compare the current image to a stored image of the empty storage compartment 257 using image processing software to determine if all of the items have been removed. For example, when a user closes the door of the storage compartment 257 after removing some items, the control station 201 may use the current image from the image capture device 273 to automatically detect and provide a warning to the user if there are items remaining in the storage compartment 257.

Some storage compartments, such as any of the storage compartments located within a storage compartment module 203, 205, 207, 209 or the control station 201, may be refrigerated storage compartments. In various implementations, such refrigerated storage compartments may include their own cooling mechanisms, or may rely on those of neighboring refrigerated storage compartments to which they are environmentally coupled, or alternatively each of the modules 201, 203, 205, 207, 209 or the entire pickup location 200 may have a centralized cooling system. The temperature of previously non-refrigerated storage compartments may be adjusted to become refrigerated storage compartments, and visa-versa. The temperature in each of the refrigerated storage compartments may be separately adjustable, such that items inside each of the refrigerated storage compartments may be cooled to a desired temperature. For example, items that need to be chilled or frozen at specified temperatures, such as groceries or medical supplies, may be stored in various refrigerated storage compartments.

In various implementations, the temperatures in the refrigerated storage compartments may be adjusted when items are delivered to be placed in the refrigerated storage compartments, or may adjusted in advance. For example, when a refrigerated item is scheduled to be delivered to a pickup location, the temperature of a refrigerated storage compartment may be adjusted to a temperature that is specified for the refrigerated item in advance so that the refrigerated storage compartment will be at the specified temperature when the item is delivered. In one implementation, the image capture device 273 may be used to capture an image of an item when it is delivered and/or placed in a storage compartment in order to try to determine an appropriate storage temperature for the item. For example, an item may have information on a label which identifies a storage temperature, such as “contents to be stored at 32 degrees F. or lower”.

The temperatures in some or all of the refrigerated storage compartments may be controlled by the control station 201. Continuous monitoring and regulating of the temperatures of the refrigerated storage compartments in which such items are kept may be important for verifying the condition of the items. Temperature sensors, such as the temperature sensor 274 of the storage compartment 257, may be utilized for monitoring and regulating the temperature inside each of the refrigerated storage compartments. The refrigerated storage compartments and/or the entire pickup location 200 may be insulated to prevent the dissipation of the cooled air from the refrigerated storage compartments.

In another example, the pickup location 200 may also include a storage compartment module configured as a drop-box (not shown). Rather than utilizing specific storage compartments of the pickup location 200 to store returned items and/or items for delivery, a storage compartment module configured as a drop-box may be utilized to securely store such items. For example, a drop-box may be configured with a pivoting door or tray that allows items to be placed in the drop-box but not retrieved without having additional access to the drop-box. In some examples, the pivoting door or other form of access may also be locked and access only provided in response to a user interacting with the user interface 211, such as selecting to return an item.

The storage compartment modules 203, 205, 207, 209 as well as the control station 201 may also include self-leveling feet 279 that may be used to level the storage compartment modules 203, 205, 207, 209 and/or control station 201 when located on un-level surfaces. In addition, the self-leveling feet 279 may also be adjusted so that a storage compartment module, such as storage compartment module 205, 207, can be positioned so it is flush and aligned with a control station 201 or another storage compartment module. As an alternative to self-leveling feet 279, any other type of support mechanism may be utilized with various implementations described herein for supporting the control station 201 or any storage compartment module 203, 205, 207, 209. Also, the control station 201 and one or more of the storage compartment modules 203, 205, 207, 209 may utilize different types of support mechanisms. For example, the control station 201 may utilize self-leveling feet while the storage compartment modules 203, 205, 207, 209 may utilize rolling casters or wheels. The casters/wheels may further enable the ease with which storage compartment modules may be added or removed from a control station 201, thereby allowing the easy addition/removal of capacity at the pickup location 200.

FIG. 3 depicts a block diagram of an illustrative distributed pickup location environment 301 that includes a group of distributed pickup locations 200(A), 200(B), 200(C), 200(D), 200(E), in one implementation. A group of corresponding geographic ranges 300(A), 300(B), 300(C), 300(D), 300(E) are served by each pickup location 200(A)-200(E). When an order for one or more items is placed by user, a shipment set may be assigned to a materials handling facility for fulfillment and delivery to the user. By strategically placing pickup locations 200, a user may select a pickup location, such as pickup location 200(A) that is in a geographically convenient location 300(A) as the delivery destination, rather than having the order delivered to their house, apartment, office or other location. This may be convenient to the user if they may not be available when the item would otherwise be delivered to the location, may not want others located at alternative delivery locations to know that they have ordered an item (e.g., a mother may not want a gift for their child delivered to the house) or may not want the item left at an unsecure location (e.g., front port, mailroom) if they are not present when the item is delivered.

When a user places an order for one or more items, an order planning system may determine if there is a pickup location, such as pickup location 200(A), within a geographic range 300(A) of where the user may wish to have the items delivered. In some instances, a user may designate or preselect preferred pickup locations 200, such as pickup location 200(A), 200(B). For example, a user may designate one pickup location 200(A) as a preferred pickup location near the user's home and a second pickup location 200(B) as a pickup location near the user's work. If an identified pickup location is available, the order planning system may determine if there is available capacity to receive the user's order prior to allowing the user to select the pickup location for delivery of an order. For items that have been ordered with a pickup location 200 designated as the delivery location, the materials handling facility 301 may prepare and ship the orders to each of those pickup locations, in some instances without requiring packaging for those orders. For example, orders assigned to pickup location 200(A) may be picked directly into one or more delivery containers, transported to the pickup location 200(A), placed in storage compartments of the pickup location 200(A) and made available for retrieval by the users.

In various implementations, the pickup locations 200(A), 200(B), 200(C), 200(D), 200(E) may communicate with one or more remote computing resources 310. The remote computing resources 310 may form a portion of a network-accessible computing platform implemented as a computing infrastructure of processors, storage, software, data access, and other components that is maintained and accessible via a network 308. The pickup locations 200(A), 200(B), 200(C), 200(D), 200(E) may communicatively couple to the remote computing resources 310 via the network 308 which may represent wired technologies (e.g., wires, USB, fiber optic cable, etc.), wireless technologies (e.g., RF, cellular, satellite, Bluetooth, etc.), and/or other connection technologies. The network 308 carries data between the pickup locations and the remote computing resources 310. For example, the communication to and from the pickup locations may utilize the main access point 232 and/or the wireless antennas of the pickup locations, such as the wireless antennas 241, 243, 231, 245, 247 described above with respect to FIG. 2. Communication may be to and from the command component of the control station for each of the pickup locations, such as the control station 201, and may also be to and from the storage compartment management components of each connected storage compartment module, such as the storage compartment modules 203, 205, 207, 209.

As illustrated, the remote computing resources 310 may include one or more servers, such as servers 320(1), 320(2), . . . , 320(N). These servers 320(1)-(N) may be arranged in any number of ways, such as server farms, stacks, and the like that are commonly used in data centers. Furthermore, the servers 320(1)-(N) may include one or more processors 322 and memory 324 which may store a storage compartment control system 326.

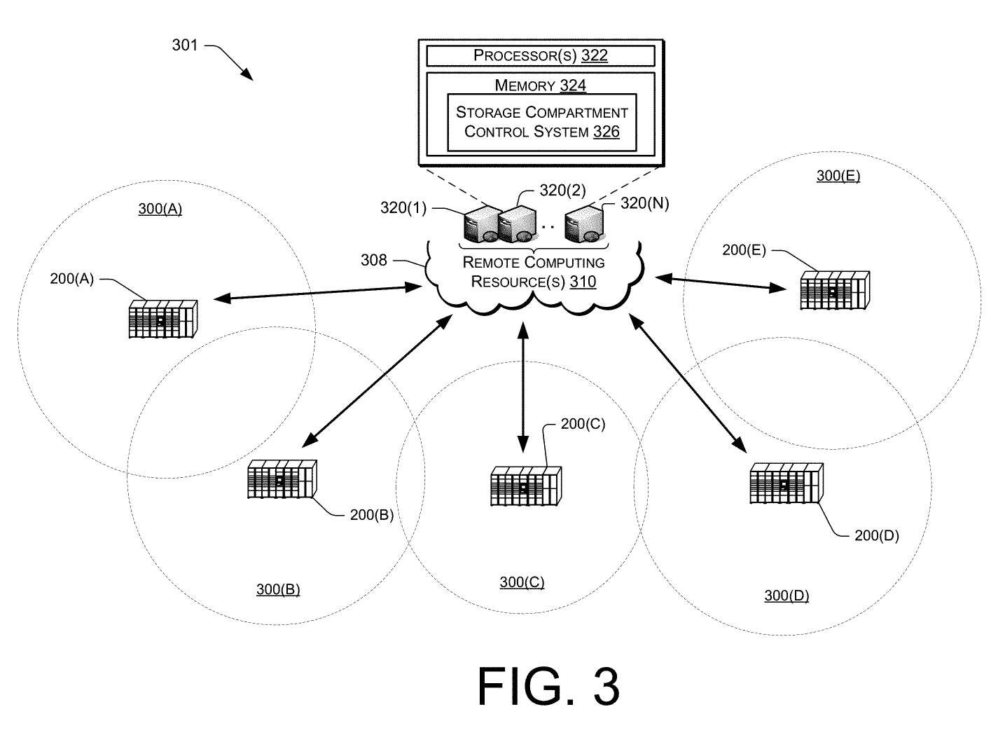

The storage compartment control system 326 may be configured, for example, to communicate with the pickup locations 200(A), 200(B), 200(C), 200(D), 200(E). In various implementations, the general activities of the pickup locations, including the presentation of content such as a message for a user or an advertisement that is selected for a user, may require synchronization with the storage compartment control system 326. For example, when an order for an item is placed, and a pickup location where the item will be delivered is selected, as will be described in more detail below with respect to FIG. 4, the storage compartment control system 326 may send certain content that is to be presented to the user to the control station 201 of the respective pickup location 200(A). The content may be presented to the user on the display 213, speakers 223 or other device of the pickup location 200(A). By sending the content before the user arrives at the pickup location, the control station 201 at the pickup location is able to store the content and present it when the user arrives, even if communications over the network are not available when the user arrives.

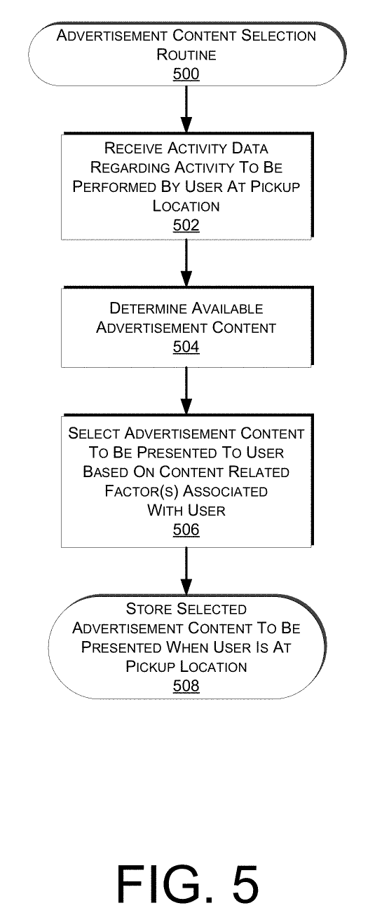

As will be described in more detail below with respect to FIG. 5, advertisement content that is to be presented to a user may be selected based on content related factors that are associated with the user. In various implementations, the process for selecting the advertisement content may be performed either at a remote computing resource 310 or a control station 201 of the pickup location. Examples of content related factors that may be utilized for selecting advertisement content include past purchases that were made by the user, a current item in an order, an item available for purchase in a store that is near the pickup location, an item on a wishlist of the user or an item in a browsing history of the user.

FIG. 4 is a flow diagram illustrating an example process 400 for processing a user order for an item. This process, and each process described herein, may be implemented by the architectures described herein or by other architectures. The process is illustrated as a collection of blocks in a logical flow graph. Some of the blocks represent operations that can be implemented in hardware, software, or a combination thereof In the context of software, the blocks represent computer-executable instructions stored on one or more computer readable media that, when executed by one or more processors, perform the recited operations. Generally, computer-executable instructions include routines, programs, objects, components, data structures, and the like that perform particular functions or implement particular abstract data types.

The computer readable media may include non-transitory computer readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations the computer readable media may include a transitory computer readable signal (in compressed or uncompressed form). Examples of computer readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the process.

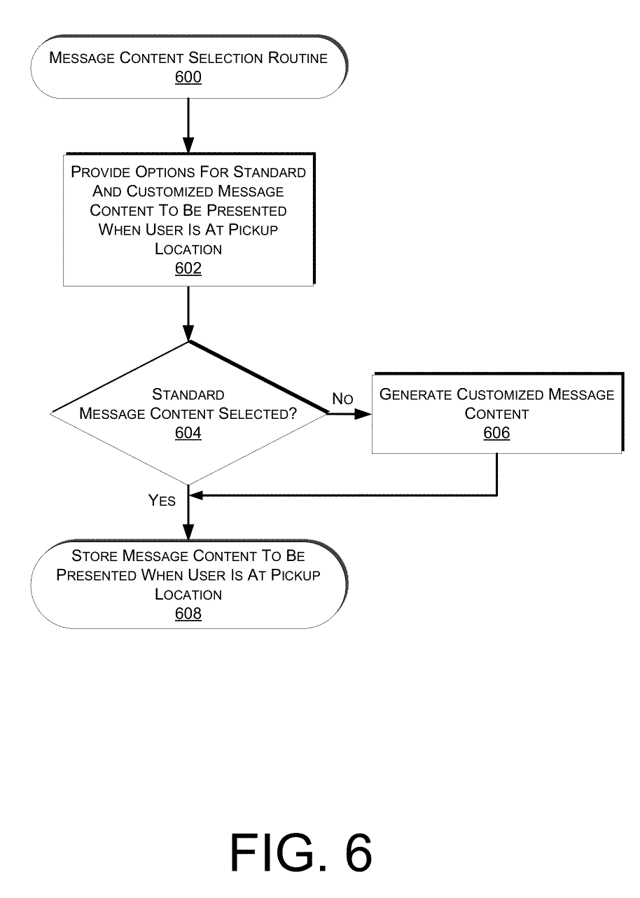

The example process 400 begins with receipt of an order for an item, as in 402. When the order is placed, a determination is made as to the pickup location to which the item will be delivered, as in 404. In various implementations, a pickup location may be selected where the item is to be delivered based on which pickup location is most convenient for the user who will be retrieving the item. Once the pickup location where the item will be delivered is determined, a determination is made as to whether content has been selected to be presented at the pickup location, as in 406. In one implementation, content that is selected to be presented at a pickup location may include an advertisement, as will be described in more detail below with respect to FIG. 5. For example, the system may determine that an advertisement should be presented to a user, and may select the advertisement from a group of advertisements that have been provided by manufacturers. In another implementation, the content that is selected to be presented at a pickup location may include a message for a user, as will be described in more detail below with respect to FIG. 6. For example, a gift purchaser may select to have a personal message that is created by the gift purchaser presented at the pickup location when the recipient arrives to retrieve the gift.

If at decision block 406 it is determined that no content has been selected to be presented to the user at the pickup location, the process completes, as in 408. If it is determined that content has been selected to be presented to the user at the pickup location, the selected content is sent to the pickup location for presentation when the user retrieves the item, as in 410. In various implementations, when the selected content is sent to the pickup location, the content is associated with the order data and/or the user so that the content will be presented when the user arrives to retrieve the item. For example, the order data may include an access code that will be used by the user to retrieve the item. The selected content may be associated with the access code when it is sent to the pickup location, so that the content will be presented to the user when the user enters the access code for retrieving the item. In various implementations, the access code may include a type of unique identifier, such as a PIN or a username and/or password. The access code may be entered by various methods, such as user typing on a keyboard or user interface of the control station, swiping a credit or other identification card through an electronic reader of the control station, etc.

FIG. 5 is a flow diagram illustrating an example process 500 for selecting advertisement content to be presented to a user. The example process begins when activity data regarding an activity to be performed by a user at a pickup location is received, as in 502. For example, as described above with respect to FIG. 4, one activity that may be performed by a user at a pickup location is the retrieval of an item that was ordered for the user. As another example, the activity to be performed at the pickup location may be the shipment of an item by a user.

Once the activity data is received, available advertisement content is determined, as in 504. In various implementations, the available advertisement content may include advertisements that are stored in a memory. Once the available advertisement content is determined, the advertisement content that is to be presented to a user is selected based on content-related factors that are associated with the user, as in 506. For example, content-related factors may include a past purchase that was made by the user, an item on a wishlist of the user or an item in a browsing history of the user, any of which may be utilized as a basis for selecting an advertisement for an associated item. Another content-related factor may include the current item in the order for the user, which may be utilized as a basis for selecting an advertisement for a complimentary item or an item that is otherwise often purchased with the current item in the order. Another content-related factor may include an item in a store that is near the pickup location where the user will be when the user retrieves the current item in the order. In such a case, the selected advertisement may also include a coupon for purchasing the advertised item at a discounted price. The advertisement may also be for an item that is currently in a storage compartment at the pickup location which the user can retrieve immediately after purchase, and which may be associated with an item that the user has previously purchased or the current item in the order.

In various implementations, the advertisement content that is selected may include a single advertisement or multiple advertisements. If multiple advertisements are to be presented, a sequence may be determined, or the advertisements may be presented simultaneously. For example, if multiple advertisements are to be simultaneously presented on a display at the pickup location, the advertisements may be adjusted and sized, or organized according to existing sizes, so as to each occupy a designated portion of the display. A user may also be provided with an option for choosing one of the multiple advertisements that are being displayed for being enlarged on the display and/or for receiving additional detail about the advertisement and/or for purchasing an item from the advertisement.

Once the advertisement content has been selected, the advertisement content is stored for presentation to the user when the user is at the pickup location, as in 508. In various implementations, when the advertisement content is stored, it may be associated with the activity data and/or the user, so that the advertisement content will be presented when the user arrives to perform the activity. For example, the activity data may include an access code to be used by the user to retrieve an item from, or place an item in, a storage compartment at the pickup location. The stored advertisement content may be associated with the access code so that when the user arrives at the pickup location and enters the access code, the stored advertisement content will be presented to the user.

In one implementation, the example process 500 including the selection and storing of the advertisement content may be performed at a control station 201 of a pickup location. In an alternative implementation, a remote computing resource 310 that receives and synchronizes information with the pickup location may be utilized to perform the selection of the advertisement content. For the remote computing resource 310, by selecting the advertisement content and storing it at a control station 201 of the pickup location in advance, the advertisement content may still be presented to the user even if the control station 201 is not able to communicate with the remote computing resource 310 over a network when the user arrives at the pickup location. Similarly, if the control station 201 has the capability for selecting the advertisement content, network connectivity may not be required when the user arrives at the pickup location in order for the advertisement content to be selected and presented to the user. In various implementations, the advertisement content may also be selected and presented on-demand For example, the advertisement content may be selected and presented during the activity that the user is performing at the pickup location, or at the end of the activity such as part of a “thank you for using the pickup location” message on the user interface of the control station. The advertisement content may also be presented automatically or the user may be provided with an option for having advertisement content selected and presented.

FIG. 6 is a flow diagram illustrating an example process 600 for selecting message content to be presented to a user. The example process begins by providing options for standard and customized message content, as in 602. For example, if a gift message is being created, the gift purchaser may be provided with options for selecting either a standard gift message or creating a customized gift message. Message templates may be provided, which in some implementations may be uploaded to the system by third parties. For example, a template for a gift message may be uploaded by a third party which may also include a credit or advertisement for the third party and/or may be available for purchase. A user may then select the template and customize it for creating a customized gift message. As another example, the message content may be provided by the user. In various implementations, a user may create a message with a reminder for a task that is to be performed when the user is at the pickup location. For example, if the pickup location is near a grocery store, the user may select a standard reminder message to pick up groceries, or may create a customized message which includes the full grocery list for the user.

Once the options for the standard or customized message content are provided, a determination is made as to whether standard message content has been selected, as in 604. If standard message content has not been selected, then customized message content is generated, as in 606. For example, a gift purchaser may type in a personalized message that is to be presented, and may select various audiovisual content options such as music, graphics, etc. to be presented with the personalized message on one or more audiovisual devices of the pickup location which may also be selected by the gift purchaser. As another example, a user who is creating a customized message including a grocery list may type in or download the grocery items, or may select from a populated list of common grocery items. After the customized message content is generated, or if standard message content is selected, the message content is stored to be presented when the user is at the pickup location, as in 608. In various implementations, when the message content is stored, it may be associated with particular activity data and/or the user so that the message content will be presented when the user arrives at the pickup location. For example, if the message content is a gift message, the message content may be associated with an access code, such that the gift message will be presented when the user enters the access code at the pickup location for retrieving the gift item.

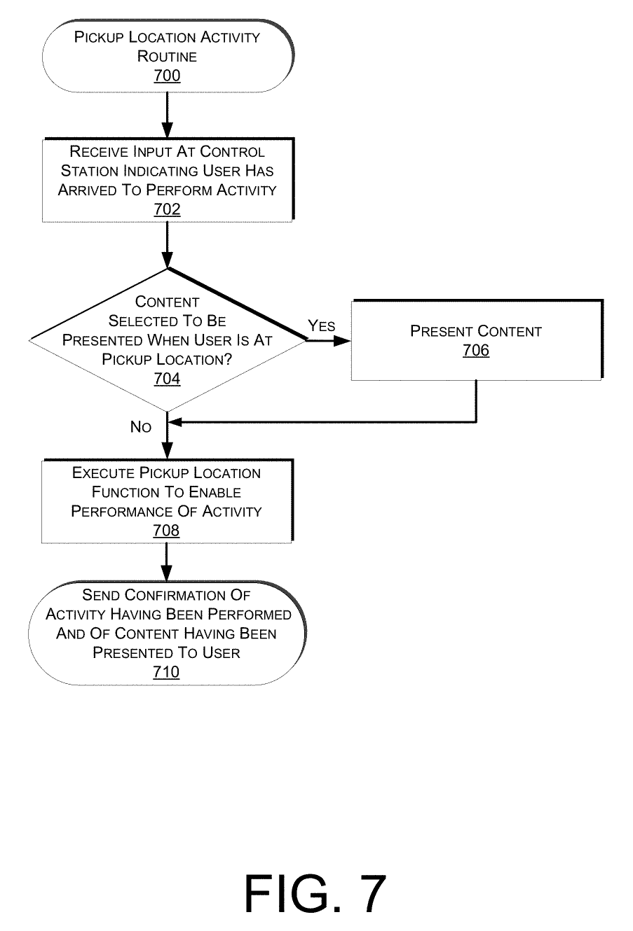

FIG. 7 is a flow diagram illustrating an example process 700 for a pickup location activity. The example process begins when an input is received at a control station of the pickup location which indicates that the user has arrived to perform an activity, as in 702. In various implementations, the input that is received at the control station may include an access code that is entered by a user for retrieving or shipping an item, or other input that identifies the user. After the input indicating that the user has arrived is received, a determination is made as to whether content has been selected to be presented when the user is at the pickup location, as in 704. If content has been selected to be presented when the user is at the pickup location, the content is presented, as in 706.

As described above with respect to FIGS. 5 and 6, in various implementations the content may include a message for the user or an advertisement that is selected for the user. In various implementations, the user may be provided with an option for having the content presented while they are at the pickup location, or at a later time. The user may also be provided with an option for having the content presented on a device of the pickup location or on a user's mobile device. The devices of the pickup location on which the content may be presented may include a display 213 and/or speakers 223, or other audiovisual devices of the pickup location, such as a projection device that may present the content on a door or other surface of the storage compartment where the item is located.

In addition, the user may be provided with an option for interacting with the content. For example, when the content is a message the user may be provided with an option for sending a response to the message through a user interface of the pickup location. For a gift message, the user may be able to send a thank you or other message back to the gift purchaser. As another example, if the content is an advertisement, the user may be provided with an option to purchase the advertised item or otherwise seek additional information about the item through a user interface of the pickup location. In one implementation, the advertisement may be for an item that is currently in a storage compartment of the pickup location, which the user can purchase and immediately retrieve.

After the content has been presented, or if no content has been selected to be presented, a pickup location function is executed to enable the performance of the activity by the user, as in 708. For example, the pickup location function may include unlocking a storage compartment where an item is stored that was ordered for the user, wherein the activity includes the user retrieving the item. As another example, the pickup location function may include processing shipping information for an item, wherein the activity includes the user shipping the item from the pickup location.

After the pickup location function has been executed to enable the performance of the activity by the user, a confirmation is sent of the activity having been performed and of the content having been presented to the user. In various implementations, a confirmation of the content having been presented to the user may be provided to the entity that generated the content. For example, if the content includes a gift message, the gift purchaser may be informed when the gift message has been presented to the user. As another example, an advertiser may receive a confirmation when an advertisement has been presented to a user.

FIG. 8 is a block diagram illustrating an example computer system 800 configured to implement one or more of the systems or processes described herein. In various examples, the block diagram may be illustrative of one or more aspects of the control station 201 (FIG. 2) and/or the remote computing resource(s) 310 (FIG. 3) discussed above. In the illustrated implementation, the computer system 800 includes one or more processors 810A, 810B through 810N, coupled to a non-transitory computer readable storage medium 820 via an input/output (I/O) interface 830. The computer system 800 further includes a network interface 840 coupled to an I/O interface 830, and one or more input/output devices 850. In some implementations, it is contemplated that components of a storage compartment control system and/or a pickup location (e.g., user interface, command component, storage compartment management component, control station) may be implemented using a single instance of the computer system 800, while in other implementations, multiple such systems or multiple nodes making up the computer system 800 may be configured to host different portions, components or instances of a storage compartment control system and/or pickup location. For example, in one implementation, some data sources or services (e.g., capturing images or video within a storage compartment, computing available space within a storage compartment, providing content to a user) may be implemented via one or more nodes of the computer system 800 that are distinct from those nodes implementing other data sources or services (e.g., providing commands to open a storage compartment, synchronizing order data, selecting an advertisement to be presented to a user). In some implementations, a given node may implement the functionality of more than one component of a storage compartment control system and/or a pickup location.

In various implementations, the computer system 800 may be a uniprocessor system including one processor 810A, or a multiprocessor system including several processors 810A-810N (e.g., two, four, eight, or another suitable number). The processors 810A-810N may be any suitable processor capable of executing instructions. For example, in various implementations the processors 810A-810N may be general-purpose or embedded processors implementing any of a variety of instruction set architectures (ISAs), such as the x86, PowerPC, SPARC, or MIPS ISAs, or any other suitable ISA. In multiprocessor systems, each of the processors 810A-810N may commonly, but not necessarily, implement the same ISA.

The non-transitory computer readable storage medium 820 may be configured to store executable instructions and/or data accessible by the one or more processors 810A-810N. In various implementations, the non-transitory computer readable storage medium 820 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described above, are shown stored within the non-transitory computer readable storage medium 820 as program instructions 825 and data storage 835, respectively. In other implementations, program instructions and/or data may be received, sent or stored upon different types of computer-accessible media, such as non-transitory media, or on similar media separate from the non-transitory computer readable storage medium 820 or the computer system 800. Generally speaking, a non-transitory, computer readable storage medium may include storage media or memory media such as magnetic or optical media, e.g., disk or CD/DVD-ROM coupled to the computer system 800 via the I/O interface 830. Program instructions and data stored via a non-transitory computer readable medium may be transmitted by transmission media or signals such as electrical, electromagnetic, or digital signals, which may be conveyed via a communication medium such as a network and/or a wireless link, such as may be implemented via the network interface 840.

In one implementation, the I/O interface 830 may be configured to coordinate I/O traffic between the processors 810A-810N, the non-transitory computer readable storage medium 820, and any peripheral devices in the device, such as the computer systems of the storage compartment modules, the network interface 840 or other peripheral interfaces, such as input/output devices 850. In some implementations, the I/O interface 830 may perform any necessary protocol, timing or other data transformations to convert data signals from one component (e.g., non-transitory computer readable storage medium 820) into a format suitable for use by another component (e.g., processors 810A-810N). In some implementations, the I/O interface 830 may include support for devices attached through various types of peripheral buses, such as a variant of the Peripheral Component Interconnect (PCI) bus standard or the Universal Serial Bus (USB) standard, for example. In some implementations, the function of the I/O interface 830 may be split into two or more separate components, such as a north bridge and a south bridge, for example. Also, in some implementations, some or all of the functionality of the I/O interface 830, such as an interface to the non-transitory computer readable storage medium 820, may be incorporated directly into the processors 810A-810N.

The network interface 840 may be configured to allow data to be exchanged between the computer system 800 and other devices attached to a network, such as other computer systems, or between nodes of the computer system 800. For example, the network interface 840 may utilize the wireless antennas 241, 243, 231, 245, 247 to allow interaction and interface between the storage compartment control system 326 and the command component of the control station 201 and the storage compartment management component of each connected storage compartment module 203, 205, 207, 209. In various implementations, the network interface 840 may support communication via wired or wireless general data networks, such as any suitable type of Ethernet network. For example, the network interface 840 may support communication via telecommunications/telephony networks such as analog voice networks or digital fiber communications networks, via storage area networks such as Fibre Channel SANs, or via any other suitable type of network and/or protocol.

Input/output devices 850 may, in some implementations, include one or more display terminals, keyboards, keypads, touchpads, scanning devices, voice or optical recognition devices, or any other devices suitable for entering or retrieving data by one or more computer systems 800. Multiple input/output devices 850, such as a user interface for the storage compartment control system 326 and/or the user interface 211, may be present in the computer system 800 or may be distributed on various nodes of the computer system 800. In some implementations, similar input/output devices may be separate from the computer system 800 and may interact with one or more nodes of the computer system 800 through a wired or wireless connection, such as over the network interface 840. For example, the computer systems of the storage compartment modules 203, 205, 207, 209 and/or the locking mechanisms of those storage compartment modules may communicate with the computer system 800 as input/output devices 850 over wired or wireless network interface 840.

As shown in FIG. 8, the memory 820 may include program instructions 825 which may be configured to implement a storage compartment control system and/or pickup location data storage 835, which may comprise various tables, databases and/or other data structures accessible by the program instructions 825. In one implementation, the program instructions 825 may include various software modules configured to implement a user interface 211, security, locking and unlocking of storage compartments, management of the pickup location, and functions of the storage compartment control system 326, such as synchronizing content that is to be presented to a user with the pickup location. The data storage 835 may include various data stores for maintaining one or more storage compartment module configurations, data representing presence or absence of items contained in various storage compartments, access information for various storage compartments and/or other item parameter values. The data storage 835 may also include one or more data stores for maintaining data representing item deliveries, retrievals, returns, hold orders, partial orders, transfer container locations, content related factors associated with a user, and other information utilized by the storage compartment control system and/or pickup location.

In various implementations, the parameter values and other data illustrated herein as being included in one or more data stores may be combined with other information not described or may be partitioned differently into more, fewer, or different data structures. In some implementations, data stores used in the storage compartment control system and/or in a pickup location and/or in components or portions thereof, may be physically located in one memory or may be distributed among two or more memories. These memories may be part of a single computer system or they may be distributed among two or more computer systems, such as two computer systems connected by a wired or wireless local area network, or through the Internet, in different implementations. Similarly, in other implementations, different software modules and data stores may make up a pickup location system and/or any of the various components thereof described herein.

Those skilled in the art will appreciate that the computing system 800 is merely illustrative and is not intended to limit the scope of the present disclosure. In particular, the computing system and devices may include any combination of hardware or software that can perform the indicated functions, including computers, network devices, internet appliances, PDAs, wireless phones, pagers, etc. The computing system 800 may also be connected to other devices that are not illustrated, or instead may operate as a stand-alone system. In addition, the functionality provided by the illustrated components may in some implementations be combined in fewer components or distributed in additional components. Similarly, in some implementations the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated computing system via inter-computer communication. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various implementations may further include receiving, sending or storing instructions and/or data implemented in accordance with the foregoing description upon a computer-accessible medium. Accordingly, the techniques described herein may be practiced with other computer system configurations.

Those skilled in the art will appreciate that in some implementations the functionality provided by the processes and systems discussed above may be provided in alternative ways, such as being split among more software modules or routines or consolidated into fewer modules or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a computer readable storage medium, other aspects may likewise be so embodied. Various modifications and changes may be made as would be obvious to a person skilled in the art having the benefit of this disclosure. It is intended to embrace all such modifications and changes and, accordingly, the above description to be regarded in an illustrative rather than a restrictive sense.

1. A system, comprising:
a pickup location apparatus where items are delivered and stored, comprising:
a storage compartment with a locking mechanism; and
a control station configured to control the locking mechanism, the control station comprising an input device and an output device; and
a computing system, comprising:
one or more processors; and
a memory coupled to the one or more processors and storing program instructions that when executed by the one or more processors cause the one or more processors to:
receive an order for a gift item for a first user and a gift message that is to be presented to the first user, wherein the order and the gift message are received from a second user;
determine that the gift item will be delivered to the pickup location apparatus for retrieval by the first user, wherein the gift message is to be presented to the first user on the output device of the control station of the pickup location apparatus when the first user retrieves the gift item from the pickup location apparatus;
direct the item to be delivered to the pickup location apparatus and stored in the storage compartment for retrieval by the first user, wherein the storage compartment is locked by the control station after the item is placed in the storage compartment
determine that the first user has arrived at the pickup location apparatus based on the input device of the control station of the pickup location apparatus having received an input that identifies the first user; and
based on the determination that the first user has arrived at the pickup location apparatus, direct the control station to unlock the storage compartment and to present the gift message that was received from the second user on the output device of the control station of the pickup location apparatus.

2-5. (canceled)

6. A pickup location apparatus where items are delivered and stored, comprising:
a storage compartment with a locking mechanism; and
a control station configured to control the locking mechanism, the control station comprising:
an input device; and
a computing system, comprising:
one or more processors; and
a memory coupled to the one or more processors and storing program instructions that when executed by the one or more processors cause the one or more processors to:
store activity data regarding an activity that will be performed by a first user at the pickup location apparatus, the activity comprising the first user providing an input that identifies the first user wherein the storage compartment is unlocked by the control station in response to the input from the first user;
store content for presentation to the first user at the pickup location apparatus, the content comprising a message for the first user that has been provided by either:
a second user who purchased the item for the first user; or
the first user;
determine that the first user has arrived at the pickup location apparatus based on the input device of the control station of the pickup location apparatus receiving the input that identifies the first user; and
based on the determination that the first user has arrived at the pickup location apparatus, present the message to the first user and unlock the storage compartment.

7. The pickup location apparatus of claim 6, wherein the activity data includes an access code and the input from the first user comprises an entry of the access code.

8. The pickup location apparatus of claim 6, wherein the program instructions when executed by the one or more processors further cause the one or more processors to receive the message over a network.

9. The pickup location apparatus of claim 8, wherein the message is received over the network to be stored in a memory of the control station before the first user arrives at the pickup location apparatus so as to enable the message to be presented to the first user at the pickup location apparatus at a time when communications over the network are not available.

10. The pickup location apparatus of claim 6, wherein the program instructions when executed by the one or more processors further cause the one or more processors to select an advertisement for the first user that is included as part of the content based on at least one of a past purchase that was made by the first user, the item in the storage compartment, an item that will be available for purchase in a store that is near the pickup location apparatus, an item on a wishlist of the first user or an item from a browsing history of the first user.

11. The pickup location apparatus of claim 6, wherein the message is a reminder message that has been provided by the first user which includes a reminder for a task when the first user is at the pickup location apparatus.

12. The pickup location apparatus of claim 6, wherein the item is purchased for the first user by the second user, the program instructions when executed by the one or more processors further cause the one or more processors to present the message as a gift message and the second user is provided with an option of selecting a standard gift message or creating a custom gift message for the first user.

13. A pickup location apparatus where items are delivered and stored, comprising:
a storage compartment with a locking mechanism; and
a control station configured to control the locking mechanism, the control station comprising:
an input device; and
a computing system, comprising:
one or more processors; and
a memory coupled to the one or more processors and storing program instructions that when executed by the one or more processors cause the one or more processors to:
receive from a remote computing resource content that is associated with an item, the content comprising a message for a first user that has been provided by either:
a second user who purchased the item for the first user; or
the first user;
receive on the input device of the control station of the pickup location apparatus an input from the first user that identifies the first user and indicates that the first user has arrived at the pickup location apparatus to retrieve the item from the storage compartment of the pickup location apparatus; and
execute a pickup location function and present the content including the message to the first user in response to the input from the first user that identifies the first user, the pickup location function comprising controlling the locking mechanism to unlock the storage compartment to enable the first user to retrieve the item from the storage compartment of the pickup location apparatus.

14. The pickup location apparatus of claim 13, wherein the pickup location function includes wirelessly sending an unlock command for controlling the locking mechanism to unlock the storage compartment where the item is stored.

15. The pickup location apparatus of claim 13, wherein a second pickup location function is executed in response to receiving an input that indicates that the first user wants to return the item, the second pickup location function including providing access to a storage compartment of the pickup location apparatus where the first user may place the item for returning the item.

16. The pickup location apparatus of claim 13, wherein the program instructions when executed by the one or more processors further cause the one or more processors to provide the first user with an option for interacting with the content through a user interface of the pickup location apparatus.

17. The pickup location apparatus of claim 16, wherein the interaction includes the first user sending a response to the second user through the user interface of the pickup location apparatus.

18. The pickup location apparatus of claim 16, wherein the content further includes an advertisement for an advertised item and the interaction includes the first user purchasing the advertised item through the user interface of the pickup location apparatus.

19. The pickup location apparatus of claim 18, wherein the advertised item is currently in a storage compartment at the pickup location apparatus from which the first user can retrieve the advertised item immediately after purchase.

20. The pickup location apparatus of claim 13, wherein the content further includes an advertisement that is selected for the first user based on at least one of a past purchase that was made by the first user, the item in the storage compartment, an item that will be available for purchase in a store that is near the pickup location apparatus, an item on a wishlist of the first user or an item from a browsing history of the first user.

21. The pickup location apparatus of claim 13, wherein the message is a reminder message from the first user including a reminder for a task when the first user is at the pickup location apparatus.

22. The pickup location apparatus of claim 13, wherein the program instructions when executed by the one or more processors further cause the one or more processors to provide the first user with an option for selecting whether or not the message will be presented while the first user is at the pickup location apparatus.

23. The pickup location apparatus of claim 22, wherein if the first user selects to not have the message presented while the first user is at the pickup location apparatus, the program instructions when executed by the one or more processors further cause the one or more processors to provide the first user with an option to select a device on which the message will be presented at a later time.

24. The pickup location apparatus of claim 13, wherein the program instructions when executed by the one or more processors further cause the one or more processors to present the message using at least one of a display device, an audio device or a projection device of the pickup location apparatus.

25. The pickup location apparatus of claim 13, wherein the program instructions when executed by the one or more processors further cause the one or more processors to provide the first user with an option for having the message presented on a device of the pickup location apparatus or a first user's device.

26. The pickup location apparatus of claim 13, wherein the second user is a gift purchaser who purchased the item as a gift item for the first user and the program instructions when executed by the one or more processors further cause the one or more processors to present the message as a gift message.

27. The pickup location apparatus of claim 26, wherein the program instructions when executed by the one or more processors further cause the one or more processors to send a confirmation to inform the second user when the gift message has been presented to the first user.

28. The system of claim 1, wherein the program instructions when executed by the one or more processors further cause the one or more processors to present the second user with a message template that is used by the second user for creating the gift message, and the message template is at least one of available for purchase by the second user or provided with an advertisement in addition to the gift message.

29. The system of claim 1, wherein the gift message includes at least one of music or graphics that are presented on the output device which comprises at least one of speakers, a display, or a projection device.
